(19) United States
(12) Patent Application Publication
(10) Pub. No.: US 2025/0382154 A1
(43) Pub. Date: Dec. 18, 2025

(54) NON-INVASIVE ELEVATOR OPERATION ANALYSIS DEVICE

(71) Applicant: CONTROLNET INTERNATIONAL INC., Taipei City (TW)

(72) Inventor: KUN CHUNG LEE, Taipei City (TW)

(73) Assignee: CONTROLNET INTERNATIONAL INC., Taipei City (TW)

(21) Appl. No.: 18/746,084

(22) Filed: Jun. 18, 2024

(51) Int. Cl. B66B 5/00; B66B 1/34; B66B 3/00; G01B 11/26; G01D 5/347

(52) U.S. Cl. CPC B66B 5/0031; B66B 1/3492; B66B 3/002; B66B 5/0025; G01B 11/26; G01D 5/3473

(57) ABSTRACT

A non-invasive elevator operation analysis device serves to analyze an operating of an elevator which includes an elevator carriage, a speed control cable and a speed control device. The analysis device includes an encoder including a guiding pulley coupled to the speed control cable or an upper pulley of the speed control device. The encoder further includes a pulse wave generator which has a circular roller coaxially connected to the guiding pulley. The pulse wave generator serves to generate a plurality of pulse waves when the circular roller rotates. An encoding side processor is connected to the encoder. The encoding side processor serves to determine a sliding speed and a sliding acceleration of the speed control cable based on a number of the pulse waves generated by the encoder, and to obtain the state of the elevator carriage by analyzing the number of the pulse waves.

### FIELD OF THE INVENTION

The present invention is related to a monitoring of an elevator operation, and in particular to a non-invasive elevator operation analysis device.

### BACKGROUND OF THE INVENTION

Elevator is an important structure in every large building. Under the long-term using, the elevator components need to be regularly updated and maintained in order to extend the life of the elevator and reduce the frequency of failure. The power consumption of the elevator is very high due to the high utilization rate of the elevator in a day, and will result in energy waste when the elevator is often in an ineffective operating state. Therefore, it is quite important to know the running status information of the elevator.

In prior arts, the elevator carriage for carrying persons or goods has a steel cable connected to a driving motor. The elevator carriage is driven to move upwards and downwards by the driving motor. In order to obtain the running status information of the elevator, an encoder must be installed on a driving shaft of the driving motor for detecting the rotation speed of the driving shaft, which is very complicated and is difficult to obtain correct information. Because different brands of elevators have different setup parameters, different systems are needed to be used to measure the driving motor shaft speed of different elevators. Basically, these parameters and data are stored in the controller of the elevator and the elevator manufacturer will not disclose the parameter information and the information of the controller, so it is very difficult for outsiders to obtain such detailed information. Moreover, there are many different types of controllers for different elevators, and obtaining these data for different controllers makes the whole operation more difficult.

Furthermore, under a long-term using, the elevator will have a position deviation or problem with smooth movement, which will easily result a gap due to the misalignment of the floor of the elevator is not aligned with the floor of the general ground when the elevator reaches a certain floor. The user may fall and be injured due to the gap when entering or exiting the elevator, or may experience a mental stress due to the shaking of the elevator during the operation. The position deviation, non-smooth movement and the shaking will result in the damage to the elevator mechanism.

### SUMMARY OF THE INVENTION

Accordingly, for improving above mentioned defects in the prior art, the object of the present invention is to provide a non-invasive elevator operation analysis device, wherein the analysis device of the present invention can be used to collect the data of the elevator in a non-invasive way by installing the encoder on the upper pulley or the speed control cable, without having to be installed on the original control box or driving motor of the elevator. Therefore, the analysis device of the present invention can be applied to various brands of elevators without being limited to different elevator models of different brands. The present invention can be combined with a predetermined data or program related to a normal operation of the elevator carriage for analyzing that whether the elevator carriage is in a normal operating state or an abnormal operating state and providing a relevant mechanical condition and an operating requirement when the elevator carriage is in an abnormal operating state. The present invention also can determine whether the elevator carriage has a position deviation based on the theoretical position, the actual position and the position displacement of the elevator, and can alert the manager when position deviation is outside a predetermined range. As a result, by the scientific digital analyzing and management of the present invention, the manager can have a more intuitive and accurate way to realize the operation stability, aging and other conditions of the elevator, which achieves a comprehensive monitoring of the elevator system.

To achieve above object, the present invention provides a non-invasive elevator operation analysis device, wherein the analysis device serves to analyze an operating of an elevator which includes an elevator carriage, a speed control cable and a speed control device; a first end and a second end of the speed control cable are respectively connected to two sides of the elevator carriage; the speed control cable forms a cyclic structure; a speed control device is positioned on an upper side of the cyclic structure formed by the speed control cable; an upper end of the speed control cable goes around an upper pulley of the speed control device; the speed control device further includes a speed control unit connected to the upper pulley; the analysis device comprising: an encoder including a guiding pulley; a rim of the guiding pulley being coupled to the speed control cable or the upper pulley; the guiding pulley being driven to be rotated by a sliding of the speed control cable; the encoder further including a pulse wave generator; the pulse wave generator having a circular roller coaxially connected to the guiding pulley; the circular roller being driven to be rotated by a rotation of the guiding pulley; the pulse wave generator serving to generate a plurality of pulse waves when the circular roller rotates; the pulse wave generator further including a counter connected to the pulse wave generator; the counter serving to calculate a number of the pulse waves generated by the pulse wave generator and output the number of the pulse waves; the number of the pulse waves being proportional to a rotated angle of the roller; and an encoding side processor connected to the encoder and serving to receive the number of the pulse waves from the encoder; the encoding side processor further serving to determine a sliding speed of the speed control cable based on the number of the pulse waves generated per unit of time, and to determine a sliding acceleration of the speed control cable based on a differential of the sliding speed; a sliding state of the speed control cable being corresponded to a state of an upward and downward moving of the elevator carriage; and the encoding side processor further serving to obtain the state of an upward and downward moving of the elevator carriage by analyzing the number of the pulse waves generated per unit of time.

### BRIEF DESCRIPTION OF THE DRAWINGS

FIG. 1 a schematic view of the elevator carriage, speed control cable and speed control device of the present invention.

FIG. 2 shows an application of the installing of the encoder of the present invention.

FIG. 3 shows a block diagram of the elements of the present invention.

FIG. 4 shows an application of the installing of the position sensor of the present invention.

FIG. 5 shows an application of the analyzing of the calculation device of the present invention.

FIG. 6 shows another application of the analyzing of the calculation device of the present invention.

FIG. 7 shows another application of the analyzing of the calculation device of the present invention.

FIG. 8 is a cross-sectional view of the roller of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

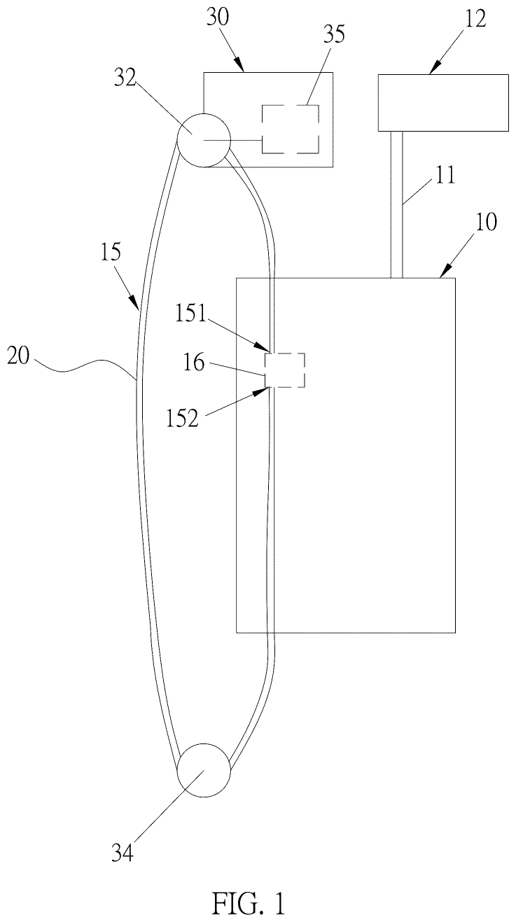

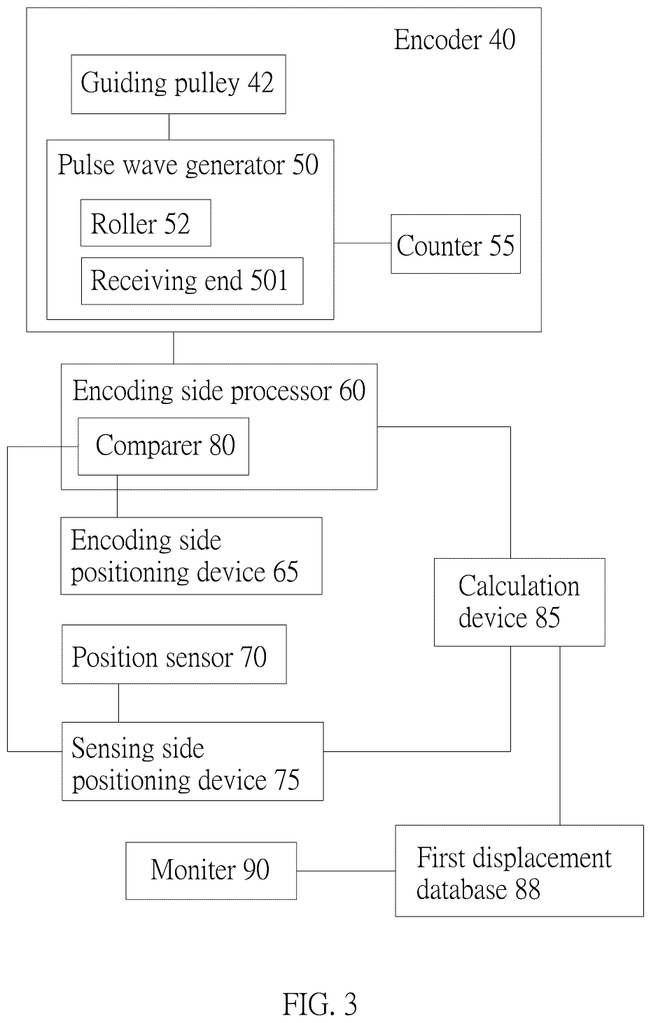

With reference to FIGS. 1 to 8, the present invention provides a non-invasive elevator operation analysis device. The analysis device serves to be connected to an elevator to analyze an operating of the elevator, wherein the elevator includes an elevator carriage 10, a speed control cable 15 and a speed control device 30.

Referring to FIG. 1, the elevator carriage 10 serves to carry persons or goods. The elevator carriage 10 has a steel cable 11 connected to a driving motor 12. The elevator carriage 10 is driven to move upwards and downwards by the driving motor 12.

A first end 151 and a second end 152 of the speed control cable 15 are respectively connected to two sides of the elevator carriage 10. The first end 151 of the speed control cable 15 is connected to an upper side of a safe plier connecting part 16 of the elevator carriage 10. The second end 152 of the speed control cable 15 is connected to a lower side of the safe plier connecting part 16 of the elevator carriage 10. The speed control cable 15 forms a cyclic structure 20.

The speed control device 30 is positioned on an upper side of the cyclic structure 20 formed by the speed control cable 15. The speed control device 30 includes an upper pulley 32. An upper end of the speed control cable 15 goes around the upper pulley 32. The speed control device 30 further includes a speed control unit 35 connected to the upper pulley 32 for detecting a rotation speed of the upper pulley 32 to achieve an over-speed detecting. A lower end of the speed control cable 15 goes around a lower pulley 34 to form the cyclic structure 20.

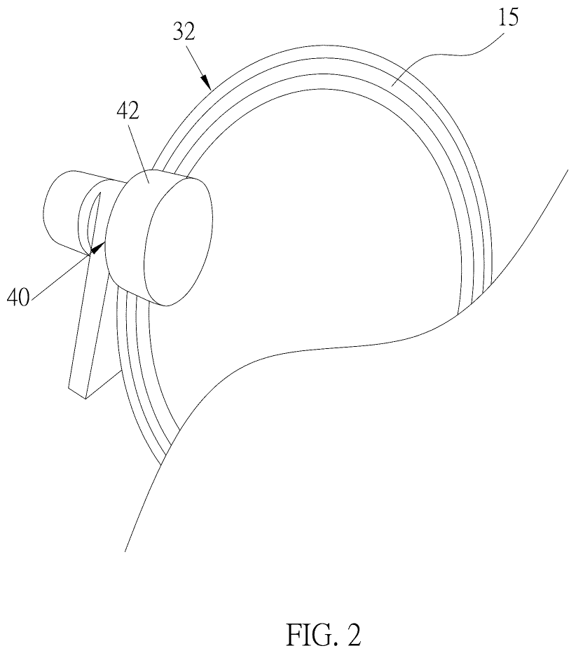

Referring to FIGS. 2 to 4, the analysis device of the present invention comprises the following elements.

An encoder 40 includes a guiding pulley 42. A rim of the guiding pulley 42 is coupled to the speed control cable 15 or the upper pulley 32 (as shown in FIG. 2). The guiding pulley 42 is driven to be rotated by a sliding of the speed control cable 15. The encoder 40 further includes a pulse wave generator 50. The pulse wave generator 50 has a circular roller 52 coaxially connected to the guiding pulley 42. The circular roller 52 is driven to be rotated by a rotation of the guiding pulley 42. The pulse wave generator 50 serves to generate a plurality of pulse waves when the circular roller 52 rotates and a number of the pulse waves is proportional to a rotated angle of the roller 52. For example, 2000 pulse waves will be generated when the roller 52 rotates 360 degrees (one turn), and 1000 pulse waves will be generated when the roller 52 rotates 180 degrees (a half turn). The rim of the guiding pulley 42 is coupled to the speed control cable 15 or the upper pulley 32 by resisting against to the speed control cable 15 or the upper pulley 32, wherein the rim of the guiding pulley 42 is movable relative to the speed control cable 15 or the upper pulley 32 (as shown in FIG. 2).

An encoding side processor 60 is connected to the encoder 40 and serves to receive the number of the pulse waves from the encoder 40. The encoding side processor 60 serves to determine a sliding speed of the speed control cable 15 based on the number of the pulse waves generated per unit of time, and to determine a sliding acceleration of the speed control cable 15 based on a differential of the sliding speed. A sliding state of the speed control cable 15 is corresponded to a state of an upward and downward moving of the elevator carriage 10. Therefore, the encoding side processor 60 serves to obtain the state of an upward and downward moving of the elevator carriage 10 by analyzing the number of the pulse waves generated per unit of time.

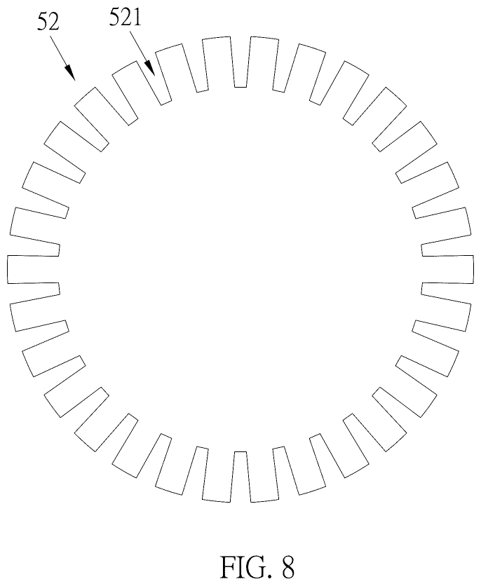

Referring to FIG. 8, the roller 52 has a plurality of slits 521 spaced by an identical angle. When a light passes a corresponding slit 521, the light is transmitted to a receiving end 501 of the pulse wave generator 50 to form a light signal and a corresponding pulse wave is generated. Each of the slits 521 is corresponded to a generating of a respective one pulse wave. In the encoding side processor 60, the rotated angle of the roller 52 is obtained by the number of the pulse waves and is corresponded to a rotated angle of the guiding pulley 42. Because the guiding pulley 42 is driven by the sliding of the speed control cable 15, a sliding distance of the speed control cable 15 can be obtained by the encoding side processor 60 based on the rotated angle of the guiding pulley 42.

For example, a circumference of the guiding pulley 42 is 20 cm, which is equal to a sliding distance of the speed control cable 15. When the speed control cable 15 slides 20 cm, the pulse wave generator 50 generates 2000 pulse waves. Therefore, the sliding distance of the speed control cable 15 can be obtained by the number of the pulse waves. For another example, when the pulse wave generator 50 generates 500 pulse waves, the sliding distance of the speed control cable 15 is 5 cm, and so on.

The encoder 40 further includes a counter 55 connected to the pulse wave generator 50. The counter 55 serves to calculate the number of the pulse waves generated by the pulse wave generator 50 and output the number of the pulse waves to the encoding side processor 60.

The encoding side processor 60 serves to calculate the sliding distance of the speed control cable 15 to obtain a position, a speed, an acceleration and a moving path of the moving of the elevator carriage 10.

An encoding side positioning device 65 is connected to the encoding side processor 60. The encoding side positioning device 65 serves to determine a theoretical position 3001 (which is not an actual position) of the elevator carriage 10 based on the position of the moving of the elevator carriage 10 obtained by the encoding side processor 60.

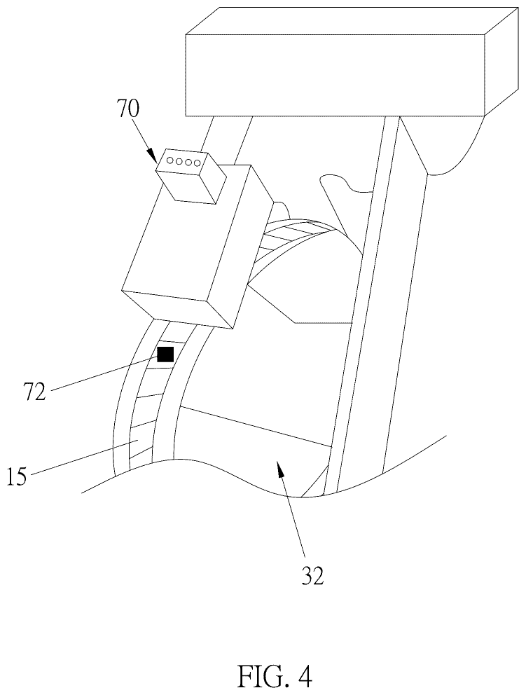

A position sensor 70 is fixed on a sliding path of the speed control cable 15. The position sensor 70 serves to detect a coordinate mark 72 on the speed control cable 15 for determining a position of the upward and downward moving of the elevator carriage 10 (as shown in FIG. 4). In the present invention, the coordinate mark 72 is fixed on the speed control cable 15. The position sensor 70 is a light sensor for emitting a detecting light. The coordinate mark 72 is detected by the position sensor 70 when the detecting light is reflected off the coordinate mark 72. Preferably, the coordinate mark 72 has a white color to have a higher light reflectivity. Therefore, the position of the upward and downward moving of the elevator carriage 10 is determined by the position sensor 70 and the coordinate mark 72. Preferably, the position sensor 70 is an infrared (IR) sensor.

A sensing side positioning device 75 is connected to the position sensor 70 and serves to record the position of the elevator carriage 10 detected by the position sensor 70. The position of the elevator carriage 10 detected by the position sensor 70 is recorded as an actual position 3002 of the elevator carriage 10.

The encoding side processor 60 includes a comparer 80 connected to the encoding side positioning device 65 and the sensing side positioning device 75. The comparer 80 serves to compare the theoretical position 3001 from the encoding side positioning device 65 and the actual position 3002 from the sensing side positioning device 75 for determining a position displacement 3003 based on a difference between the theoretical position 3001 and the actual position 3002.

A calculation device 85 is connected to the encoding side processor 60 and the sensing side positioning device 75. The calculation device 85 serves to receive the position, the speed, the acceleration and the moving path of the moving of the elevator carriage 10 from the encoding side processor 60, and receive the theoretical position 3001 from the encoding side positioning device 65 and the actual position 3002 from the sensing side positioning device 75, and receive the position displacement 3003 from the comparer 80 for performing a extended calculating and analyzing.

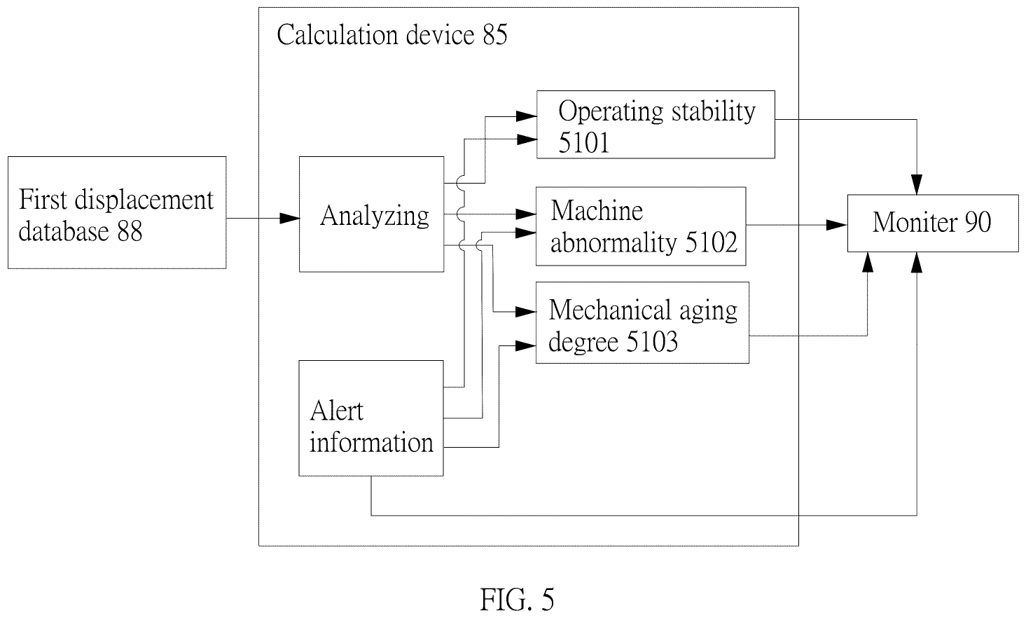

Referring to FIG. 5, the calculation device 85 serves to analyze the position, the speed and the acceleration of the moving of the elevator carriage 10 from the encoding side processor 60 for obtaining an operating stability 5101 to determine a machine abnormality 5102 or a mechanical aging degree 5103 of the elevator carriage 10. An analyzing result including the machine abnormality 5102 and the mechanical aging degree 5103 are stored in a first displacement database 88 connected to the calculation device 85 for being displayed to a related manager. The analyzing result is combined with a predetermined data or program related to a normal operation of the elevator carriage 10 for analyzing that whether the elevator carriage 10 is in a normal operating state or an abnormal operating state. The calculation device 85 also serves to output an information about a relevant mechanical condition and an operating requirement when the elevator carriage 10 is in an abnormal operating state. The calculation device 85 also serves to output an alert information to the manager when the speed or the acceleration of the elevator carriage 10 is outside a predetermined range.

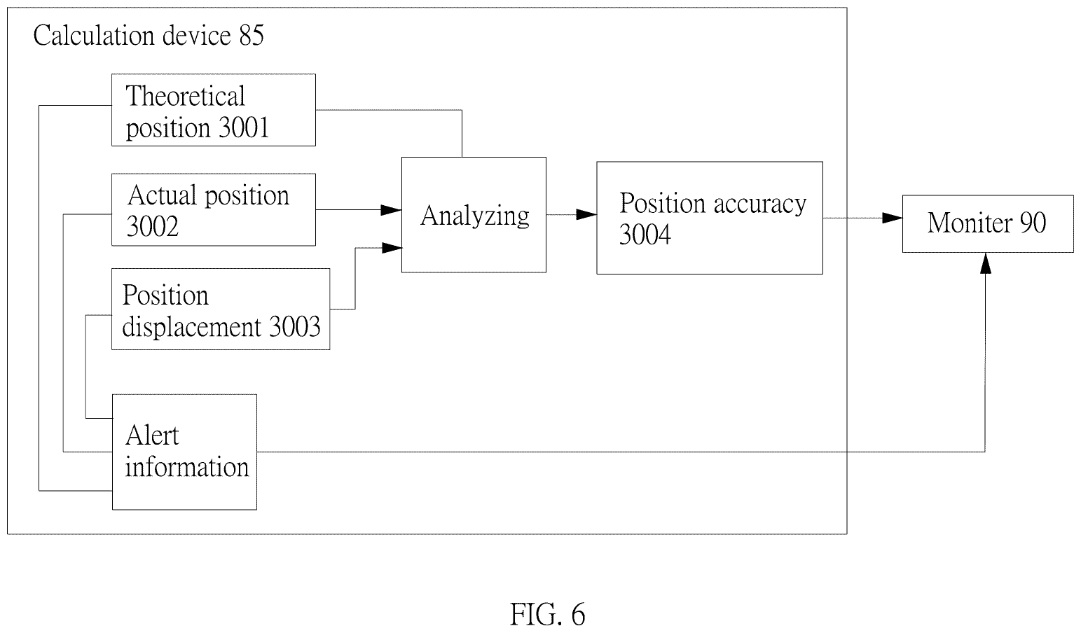

Referring to FIG. 6, the calculation device 85 further serves to determine whether the elevator carriage 10 has a position deviation based on the theoretical position 3001, the actual position 3002 and the position displacement 3003, and to obtain a stop position accuracy 3004 of a stop position of the elevator carriage 10 at different floors according to the position deviation. The position deviation and the position accuracy 3004 are stored in the first displacement database 88 for reviewing the operating of the elevator carriage 10. The calculation device 85 further serves to output an alert information to the manager when the stop position accuracy 3004 is outside a predetermined range.

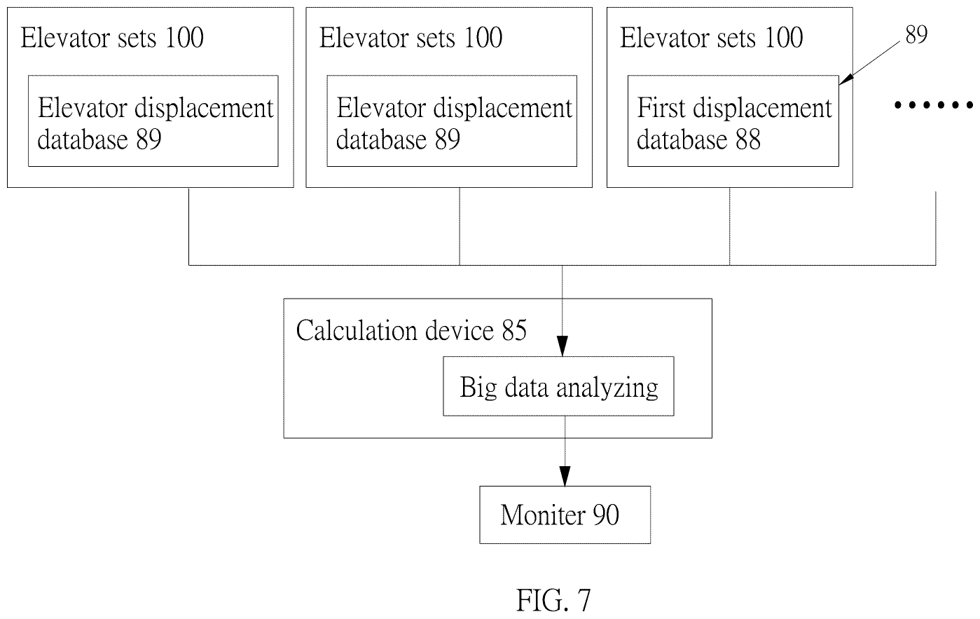

Referring to FIG. 7, the calculation device 85 further serves to perform a big data analyzing on a data of the first displacement database 88. In the present invention, a plurality of elevator displacement databases 89 are respectively positioned in a plurality of elevator sets 100 which are connected to a monitor 90. The elevator displacement databases 89 include the first displacement database 88 and are connected to the calculation device 85. A function of each of the elevator displacement databases 89 is identical to that of the first displacement database 88. The monitor 90 serves to simultaneously monitor all of the elevator sets 100 or at least one of the elevator sets 100 through the elevator displacement databases 89.

As a result, the manager can realize the actual condition of the elevator carriage 10 according to above data and analyzing of the present invention, and can know that whether the elevator carriage 10 is well maintained by an elevator maintenance company. The data and analyzing of the present invention can be also used as a maintenance reference for the elevator maintenance company.

The monitor 90 is connected to above relevant components such as the calculation device 85 and the first displacement database 88 for displaying the data from the above components.

The advantages of the present invention are that the analysis device of the present invention can be used to collect the data of the elevator in a non-invasive way by installing the encoder on the upper pulley or the speed control cable, without having to be installed on the original control box or driving motor of the elevator. Therefore, the analysis device of the present invention can be applied to various brands of elevators without being limited to different elevator models of different brands. The present invention can be combined with a predetermined data or program related to a normal operation of the elevator carriage for analyzing that whether the elevator carriage is in a normal operating state or an abnormal operating state and providing a relevant mechanical condition and an operating requirement when the elevator carriage is in an abnormal operating state. The present invention also can determine whether the elevator carriage has a position deviation based on the theoretical position, the actual position and the position displacement of the elevator, and can alert the manager when position deviation is outside a predetermined range. As a result, by the scientific digital analyzing and management of the present invention, the manager can have a more intuitive and accurate way to realize the operation stability, aging and other conditions of the elevator, which achieves a comprehensive monitoring of the elevator system.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A non-invasive elevator operation analysis device, wherein the analysis device serves to analyze an operating of an elevator which includes an elevator carriage, a speed control cable and a speed control device; a first end and a second end of the speed control cable are respectively connected to two sides of the elevator carriage; the speed control cable forms a cyclic structure; a speed control device is positioned on an upper side of the cyclic structure formed by the speed control cable; an upper end of the speed control cable goes around an upper pulley of the speed control device; and the speed control device further includes a speed control unit connected to the upper pulley;
the analysis device comprising:
an encoder including a guiding pulley; a rim of the guiding pulley being coupled to the speed control cable or the upper pulley; the guiding pulley being driven to be rotated by a sliding of the speed control cable; the encoder further including a pulse wave generator; the pulse wave generator having a circular roller coaxially connected to the guiding pulley; the circular roller being driven to be rotated by a rotation of the guiding pulley; the pulse wave generator serving to generate a plurality of pulse waves when the circular roller rotates; the pulse wave generator further including a counter connected to the pulse wave generator; the counter serving to calculate a number of the pulse waves generated by the pulse wave generator and output the number of the pulse waves; the number of the pulse waves being proportional to a rotated angle of the roller; and
an encoding side processor connected to the encoder and serving to receive the number of the pulse waves from the encoder; the encoding side processor further serving to determine a sliding speed of the speed control cable based on the number of the pulse waves generated per unit of time, and to determine a sliding acceleration of the speed control cable based on a differential of the sliding speed; a sliding state of the speed control cable being corresponded to a state of an upward and downward moving of the elevator carriage; and the encoding side processor further serving to obtain the state of an upward and downward moving of the elevator carriage by analyzing the number of the pulse waves generated per unit of time.

2. The non-invasive elevator operation analysis device as claimed in claim 1, wherein the roller has a plurality of slits spaced by an identical angle; when a light passes a corresponding slit, the light is transmitted to a receiving end of the pulse wave generator to form a light signal and a corresponding pulse wave is generated; each of the slits is corresponded to a generating of a respective one pulse wave; in the encoding side processor, the rotated angle of the roller is obtained by the number of the pulse waves and is corresponded to a rotated angle of the guiding pulley; and a sliding distance of the speed control cable is obtained by the encoding side processor based on the rotated angle of the guiding pulley.

3. The non-invasive elevator operation analysis device as claimed in claim 1, further comprising an encoding side positioning device connected to the encoding side processor;
wherein the encoding side processor serves to calculate the sliding distance of the speed control cable to obtain a position, a speed, an acceleration and a moving path of the moving of the elevator carriage; and
wherein the encoding side positioning device serves to determine a theoretical position of the elevator carriage based on the position of the moving of the elevator carriage obtained by the encoding side processor.

4. The non-invasive elevator operation analysis device as claimed in claim 3, further comprising a position sensor fixed on a sliding path of the speed control cable; the position sensor serving to detect a coordinate mark on the speed control cable for determining a position of the upward and downward moving of the elevator carriage.

5. The non-invasive elevator operation analysis device as claimed in claim 4, wherein the coordinate mark is fixed on the speed control cable; the position sensor is a light sensor for emitting a detecting light; the coordinate mark is detected by the position sensor when the detecting light is reflected off the coordinate mark; and the position of the upward and downward moving of the elevator carriage is determined by the position sensor and the coordinate mark.

6. The non-invasive elevator operation analysis device as claimed in claim 5, further comprising a sensing side positioning device connected to the position sensor and serving to record the position of the elevator carriage detected by the position sensor; the position of the elevator carriage detected by the position sensor being recorded as an actual position of the elevator carriage.

7. The non-invasive elevator operation analysis device as claimed in claim 6, wherein the encoding side processor includes a comparer connected to the encoding side positioning device and the sensing side positioning device; and the comparer serves to compare the theoretical position from the encoding side positioning device and the actual position from the sensing side positioning device for determining a position displacement based on a difference between the theoretical position and the actual position.

8. The non-invasive elevator operation analysis device as claimed in claim 7, further comprising a calculation device connected to the encoding side processor and the sensing side positioning device; the calculation device serving to receive the position, the speed, the acceleration and the moving path of the moving of the elevator carriage from the encoding side processor, and receive the theoretical position from the encoding side positioning device and the actual position from the sensing side positioning device, and receive the position displacement from the comparer for performing a extended calculating and analyzing.

9. The non-invasive elevator operation analysis device as claimed in claim 1, further comprising a calculation device connected to the encoding side processor; and
wherein the calculation device serves to analyze the position, the speed and the acceleration of the moving of the elevator carriage from the encoding side processor for obtaining an operating stability to determine a machine abnormality or a mechanical aging degree of the elevator carriage; an analyzing result including the machine abnormality and the mechanical aging degree are stored in a first displacement database connected to the calculation device for being displayed to a related manager; and the analyzing result is combined with a predetermined data or program related to a normal operation of the elevator carriage for analyzing that whether the elevator carriage is in a normal operating state or an abnormal operating state.

10. The non-invasive elevator operation analysis device as claimed in claim 8, wherein the calculation device serves to analyze the position, the speed and the acceleration of the moving of the elevator carriage from the encoding side processor for obtaining an operating stability to determine a machine abnormality or a mechanical aging degree of the elevator carriage; an analyzing result including the machine abnormality and the mechanical aging degree are stored in a first displacement database connected to the calculation device for being displayed to a related manager; and the analyzing result is combined with a predetermined data or program related to a normal operation of the elevator carriage for analyzing that whether the elevator carriage is in a normal operating state or an abnormal operating state.

11. The non-invasive elevator operation analysis device as claimed in claim 10, wherein the calculation device further serves to output an information about a relevant mechanical condition and an operating requirement when the elevator carriage is in an abnormal operating state; and the calculation device further serves to output an alert information to the manager when the speed or the acceleration of the elevator carriage is outside a predetermined range.

12. The non-invasive elevator operation analysis device as claimed in claim 11, wherein the calculation device further serves to determine a stop position accuracy of a stop position of the elevator carriage at different floors based on the theoretical position, the actual position and the position displacement.

13. The non-invasive elevator operation analysis device as claimed in claim 12, wherein the calculation device further serves to output an alert information to the manager when the stop position accuracy is outside a predetermined range.

14. The non-invasive elevator operation analysis device as claimed in claim 10, wherein the calculation device further serves to perform a big data analyzing on a data of the first displacement database; a plurality of elevator displacement databases are respectively positioned in a plurality of elevator sets which are connected to a monitor; the elevator displacement databases include the first displacement database and are connected to the calculation device; a function of each of the elevator displacement databases is identical to that of the first displacement database; and the monitor serves to simultaneously monitor all of the elevator sets or at least one of the elevator sets through the elevator displacement databases.
